(19) United States
(12) Patent Application Publication
(10) Pub. No.: US 2022/0070225 A1
(43) Pub. Date: Mar. 3, 2022

(54) METHOD FOR DEPLOYING WORKLOADS ACCORDING TO A DECLARATIVE POLICY TO MAINTAIN A SECURE COMPUTING INFRASTRUCTURE

(71) Applicant: VMware, Inc., Palo Alto, CA (US)

(72) Inventors: Chen DRORI, Saratoga, CA (US); Michael A. FOLEY, Hubbardston, MA (US); Jesse POOL, Ottawa (CA); Nishant ARYA, San Ramon, CA (US)

(21) Appl. No.: 17/011,286

(22) Filed: Sep. 3, 2020

(51) Int. Cl. H04L 29/06; G06F 9/50

(52) U.S. Cl. CPC H04L 63/205; H04L 69/28; G06F 9/5027

(57) ABSTRACT

A method for placing a workload on one or more resources based on security requirements of the workload, a declared security policy, and security capabilities of the resources, includes determining the security requirements of the workload and the declared security policy, searching for and finding a resource that meets the security requirements of the workload and the declared security policy, and deploying the workload onto the resource. The method further includes, after deploying the workload onto the resource, discovering that the resource does not meet the security requirements of the workload and the declared security policy, determining that a new environment has a resource having security capabilities that meet the security requirements of the workload and the declared security policy, and deploying the workload onto the resource in the new environment.

### BACKGROUND

Current systems for managing an environment based on security requirements are focused either on declarative-state desired topology (e.g., Kubernetes®) or on security monitoring (various agent-based threat detection systems or threat prevention systems). Such systems rely on the assumption that the security of the underlying environment resources on which the workloads are running has been guaranteed. If and when a resource is unable to provide the assumed security guarantees (either at the time of initial setup or at any time during normal operations), there is no way to adjust to and/or remediate the situation.

### BRIEF DESCRIPTION OF THE DRAWINGS

FIG. 1 depicts components in a data center in which embodiments may be implemented.

FIG. 2A depicts a representative host computer system.

FIG. 2B depicts a security module.

FIG. 2C depicts a software stack for the security module of FIG. 2B.

FIG. 3 depicts a set of possible security policy elements and a security policy for workloads of different types, according to an embodiment.

FIG. 4 depicts a flow of operations for a deploy and run function, according to an embodiment.

FIG. 5 depicts a flow of operations for a policy evaluation function, according to an embodiment.

FIG. 6 depicts a flow of operations for generating a re-evaluation function, according to an embodiment.

### DETAILED DESCRIPTION

Embodiments described herein provide a way to declaratively and automatically establish a secure computing environment by matching workloads with resources based on the security requirements of the workloads and the security capabilities of the resources based on a desired-state declarative security policy.

Embodiments may use a framework in which resources can make claims associated with a set of security capabilities, which can be independently verified using common frameworks, such as attestation with a Trusted Platform Module (TPM). However, any kind of attestation can be used. These resources can then be matched with workloads, which in turn are associated with their own set of security requirements, guaranteeing that the workloads' security requirements are satisfied. This guarantee allows the user or operator to specify a security policy, including elements defining practically anything from required levels of encryption, isolation, memory-protection, over-the-wire-encryption, time-of-day-use, geofencing, data-retention standards, etc. and be able to guarantee that workloads requirements are dynamically and automatically satisfied, even when the underlying infrastructure changes. In some embodiments, a security policy can be tailored to and different for different workloads.

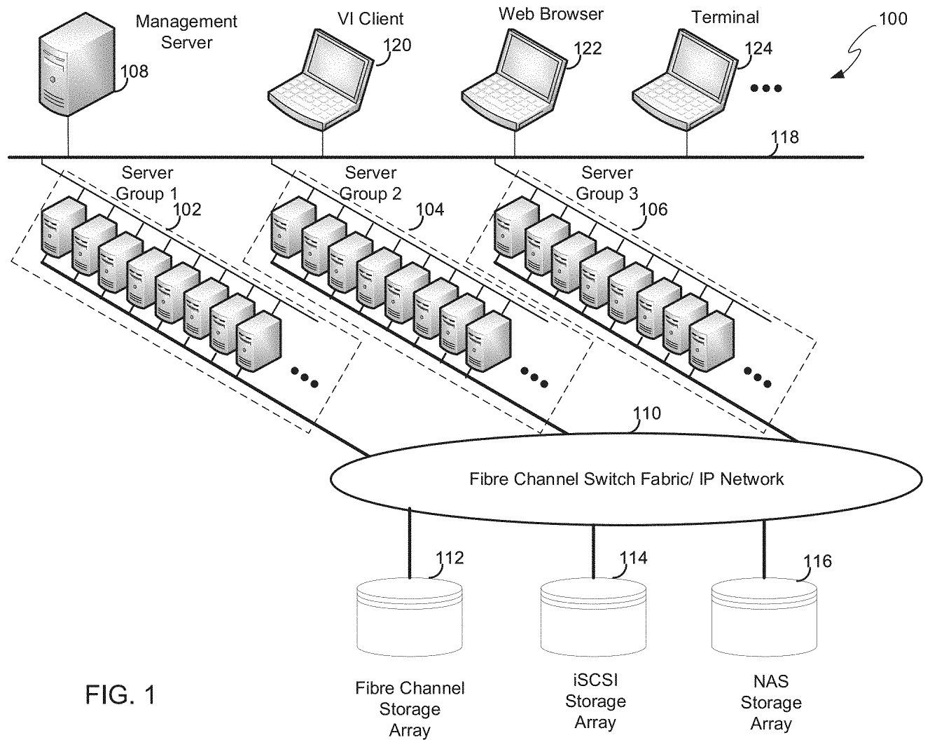

FIG. 1 depicts components in a data center in which embodiments may be implemented. As shown, the data center 100 includes several groups 102, 104, 106 of servers, each server of which is coupled to a main IP network 118 and a storage network switch fabric 110. Included in main IP network 118 and storage network switch fabric 110 are one or more routers and one or more switches coupled to the routers (not shown). Also coupled to main IP network 118 are a management server 108, several user access devices such as a VI (virtual infrastructure) client 120, a web browser device 122, or terminal device 124. One of a Fibre Channel Storage Array 112, an iSCSI storage array 114 or a NAS storage array 116 is coupled to storage network switch fabric 110.

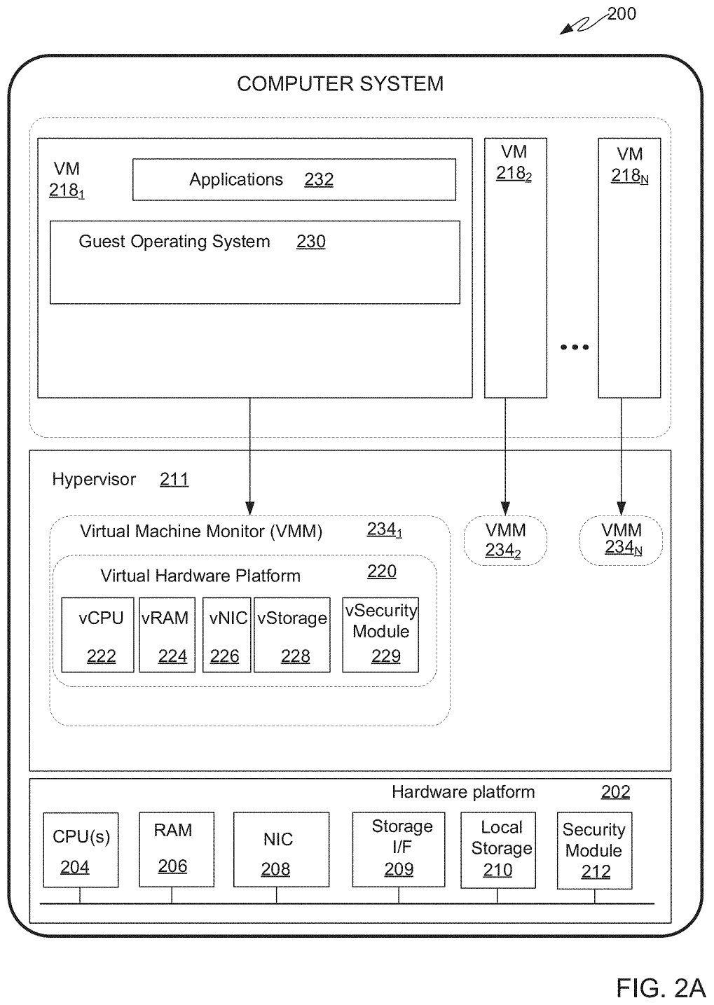

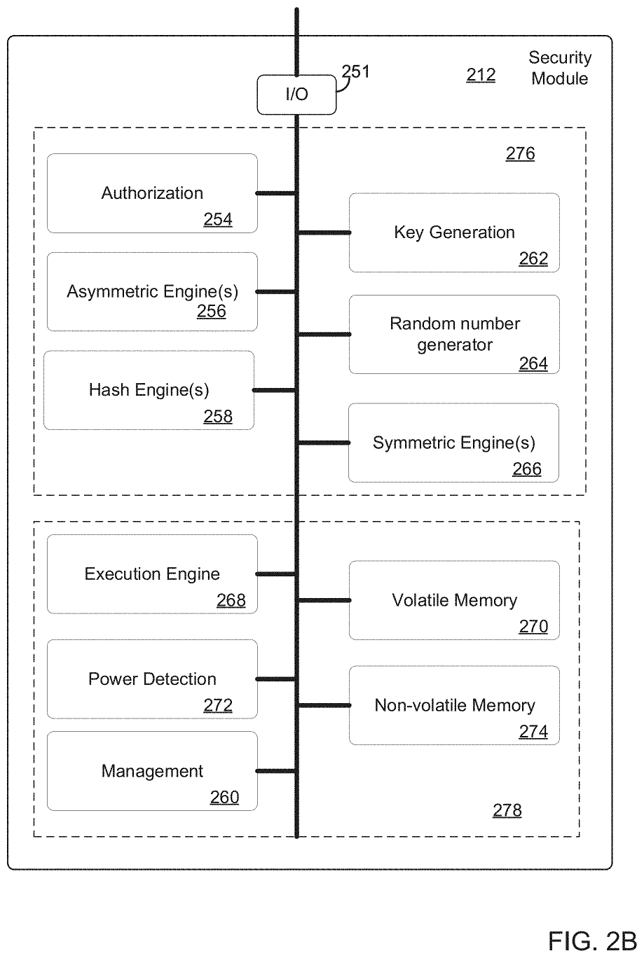

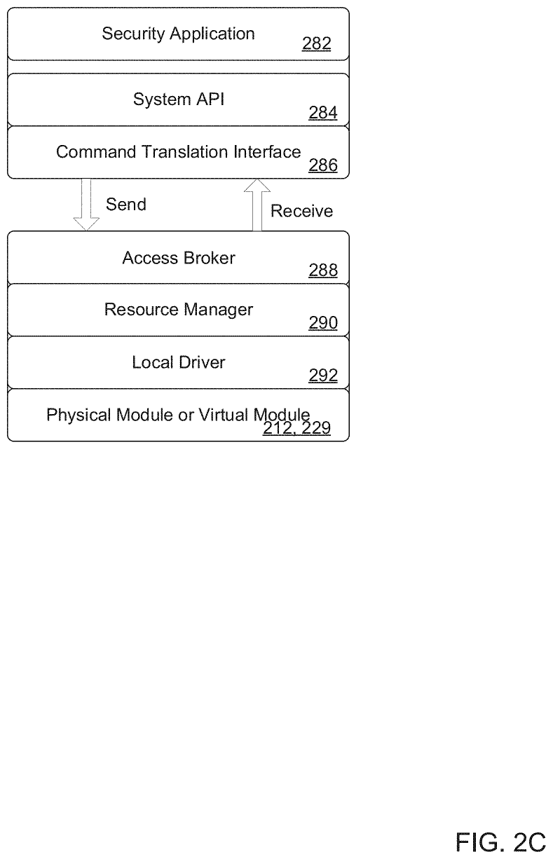

FIG. 2A depicts components of a server (such as those in groups 102, 104, 106, or management server 108) in data center 100, in an embodiment. As is illustrated, host computer system 200 hosts multiple virtual machines (VMs) 2181-218N that run on and share a common hardware platform 202.

Hardware platform 202 includes conventional computer hardware components, such as one or more items of processing hardware such as physical central processing units (CPUs) 204, a network interface controller (NIC) 208, a storage interface 209 (e.g., host bus adapter), local storage 210 (e.g., hard disk drive (HDD) and/or solid state drive (SSD)), and a physical security module 212.

A virtualization software layer, referred to hereinafter as hypervisor 211, is installed on top of hardware platform 202. Hypervisor 211 makes possible the concurrent instantiation and execution of one or more VMs 2181-218N. The interaction of a VM 218 with hypervisor 211 is facilitated by corresponding virtual machine monitors (VMMs) 234. Each VMM 2341-234N is assigned to and monitors a corresponding VM 2181-218N. In one embodiment, hypervisor 211 may be a hypervisor implemented as a commercial product in VMware's vSphere® virtualization product, available from VMware Inc. of Palo Alto, Calif. In an alternative embodiment, hypervisor 211 runs on top of a host operating system which itself runs on hardware platform 202. In such an embodiment, hypervisor 211 operates above an abstraction level provided by the host operating system.

After instantiation, each VM 2181-218N encapsulates a physical computing machine platform that is executed under the control of hypervisor 211. Virtual devices of a VM 218 are embodied in a virtual hardware platform 220, which is comprised of, but not limited to, a virtual CPU (vCPU) 222, a virtual random access memory (vRAM) 224, a virtual network interface adapter (vNIC) 226, virtual storage (vStorage) 228 and a virtual security module (vSecurity Module) 229. Virtual hardware platform 220 supports the installation of a guest operating system (guest OS) 230, which is capable of executing applications 232. Examples of a guest OS 230 include any of the well-known commodity operating systems, such as the Microsoft Windows® operating system, and the Linux® operating system, and the like.

It should be recognized that the various terms, layers, and categorizations used to describe the components in FIG. 2A may be referred to differently without departing from their functionality or the spirit or scope of the disclosure. For example, each VMM 2341-234N may be considered to be a component of its corresponding virtual machine since each VMM 2341-234N includes the hardware emulation components for the virtual machine. For example, the conceptual layer described as virtual hardware platform 220 is included in VMM 2341. Alternatively, each VMM 2341-234N may be considered separate virtualization components between VM 2181-218N and hypervisor 211 since there exists a separate VMM for each instantiated VM. Further, though certain embodiments are described with respect to VMs, the techniques described herein may similarly be applied to other types of virtual computing instances, such as containers.

In the embodiments illustrated herein, virtual compute, storage, and networking resources are provisioned from the hardware resources in data center 100. For example, virtual compute resources are provisioned from the hardware platform of host computer system 200 by hypervisor 211 running in host computer system, and virtual storage resources are provisioned from one or more of storage arrays 112, 114, 116. In some embodiments, virtual storage resources are provisioned as a virtual storage area network (vSAN) device from local hard disk drives and/or solid state drives of host computer systems 200. In addition, virtual networking resources are provisioned from switches, routers, and network interface controllers.

FIG. 2B depicts a security module included in the server. Security module 212 includes, according to an embodiment, a first group 276 of hardware blocks that provide security functions or security-related functions and a second group 278 of hardware blocks that run or manage the security or security-related blocks.

Hardware blocks in first group 276 provide security and security-related functions and include a random number generator (RNG) 264, an asymmetric engine 256, a symmetric engine 266, a hash engine 258, a key generation engine 262, an authorization engine 254.

RNG 264 consists of an entropy source and collector, a state register, and a mixing function. The entropy collector collects entropy from the entropy sources and removes bias. The collected entropy is then used to update the state register providing input to the mixing function to produce random numbers. The mixing function can be implemented with a pseudo-random number generator.

Asymmetric engine 256 provides asymmetric algorithms for attestation, identification, and secret sharing. Symmetric engine 266 provides symmetric encryption to encrypt some command parameters, and to encrypt protected objects stored outside of security module 212.

Hash engine 258 provides hash functions and is used to provide integrity checking and authentication, as well as one-way functions. Hash engine 258 also implements the Hash Message Authentication Code (HMAC) algorithm.

Key generation engine 262 provides two different types of keys. The first type is produced using the random number generator to seed the computation. The result of the computation is a secret key that is kept in a shielded location. The second type is derived from a seed value and not RNG 264 directly. The second type of key is based on the use of an approved key derivation function.

Authorization engine 254 is called at the beginning and end of command execution. Before the command is executed, authorization engine 254 checks that proper use of a shielded location is provided. Authorization engine 254 uses hash engine 258 and sometimes asymmetric engine 256.

Hardware blocks in second group 278 run or manage the security or security-related blocks and include an execution engine 268, volatile memory 270, non-volatile memory 274, management 260, and power detection 272.

Volatile memory 270 stores transient data for security module 212, which is data that is allowed to be lost when security module 212 power is removed. Non-volatile memory 274 stores persistent state associated with security module 212.

Non-volatile memory 274 contains shielded locations. Shielded locations include platform configuration registers (PCRs). One or more PCRs maintain an accumulative hash of log entries that track the events that affect the security state of the platform. Security module 212 can provide an attestation of the value in a PCR, which in turn, verifies the content of the log.

Management 260 manages operational states and control domains of security module 212. The operational states include a power-off state, an initialization state, a startup state, and a shutdown state. The startup state puts security module 212 into an operational state, in which it is ready to receive commands. Control domains determine the entity that controls security module 212.

Execution engine 268 performs commands that are sent to security module 212. Two of the many commands which the security module supports are a PCR_Extend command and a Quote command, which are used in attestation operations. Execution of the PCR_Extend command causes an update to a specified PCR, which is the primary way that PCR values are changed. The PCR_Extend command takes new data stored in a buffer in security module 212, concatenates that data with a hash value (also called a digest) of the specified PCR, applies a hash algorithm to the concatenated data and then stores the hash result into the specified PCR, thus updating the specified PCR.

The Quote command computes a digest of a concatenation of values of a selected list of PCRs, and signs the resulting digest. Power detection 272 detects the power states of security module 212. These states include power on and power off states. Both groups 276, 278 are coupled to an I/O block 251, which provides access by software external to security module 212. In some embodiments, security module 212 is virtualized and provided as a virtual security module 229, as depicted in FIG. 2A.

FIG. 2C depicts a software stack for using the security module, according to an embodiment. The layers of the stack include a security application 282, a system API 284, a command translation interface 286, an access broker 288, a resource manager 290, a local device driver 292, and a physical or virtual module, such physical security module 212 or virtual security module 229 in FIG. 2A.

System API 284 provides access to all of the capabilities of security module 212. These include command context allocation, command preparation, command execution, and command completion. Command translation interface 286 is a per-process per security module interface for transmitting and receiving a context structure for security module 212. Access broker 288 is a single-threading interface that allows the sharing of a single security module. Resource manager 290 is a virtual memory manager that swaps out and loads resources so that commands in a current context can operate. Local device driver 292 is the low-level interface to the module that receives a buffer, sends the buffer to physical security module 212, or virtual security module 229, reads a response from the module, and sends the response to the higher layers.

The software stack and the physical or virtual module can be used for several purposes, which include at least: (1) device identification using private keys embedded in the device; (2) encryption of keys, passwords and files; (3) key storage such as for root keys for certificate chains and for endorsement keys used to decrypt certificates; (4) storage for representation of the state of a machine; and (5) storage for decryption keys. In addition, the local device driver may store an event log events in an event log file, which is used to reconstruct and validate PCR values against known values. The local device driver may not only provide storage for the event log files but also provide interfaces to update the log files on PCR extends and access the log files for attestation purposes.

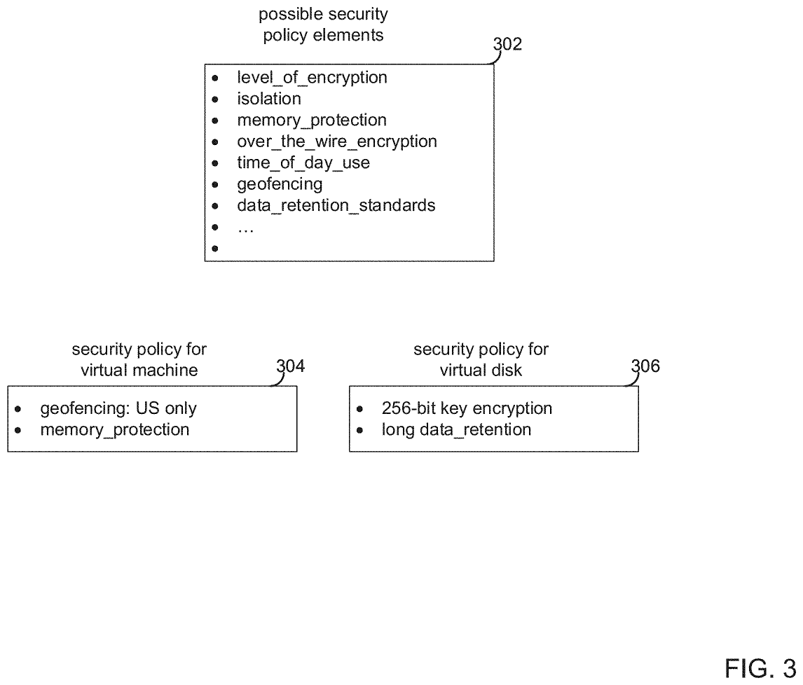

FIG. 3 depicts a set of possible security policy elements and a security policy for two types of workloads, a virtual machine and a virtual disk, according to an embodiment. As shown, list 302 is a list of possible security elements, such as a level of encryption, isolation, memory protection, over the wire encryption, time of day for allowed use, geofencing, and data retention standards. The level of encryption is determined by the size of the key, where encryption with a 128-bit key is a lower level of encryption than one using 256 bits. Isolation is determined by whether a process is able to execute independently and without improper interaction with (i.e., to be “isolated” from) other processes. Memory protection is determined by whether the data of the workload resides in an area of memory that has protected access. Over-the-wire encryption is determined by whether data in transit that is sent to or received from the workload is encrypted. Time of day is determined by a setting a period of time during which the workload is allowed to run. Geofencing is determined by whether running the workload in a particular location is permitted. Data retention standards are determined by whether and how long the workload data and metadata are saved after the workload runs to completion.

Also shown in FIG. 3 are example security policies for a virtual machine and a virtual disk. For the virtual machine, the security policies 304 selected from the possible security policy elements are geofencing: US only, and memory protection. For the virtual disk, the security policies 306 selected from the possible security elements are 256-bit key encryption and long data retention. In certain embodiments, the security policies for a workload, such as a virtual machine or virtual disk, are input by a user or operator of data center 100 through a user interface for accessing management server 108.

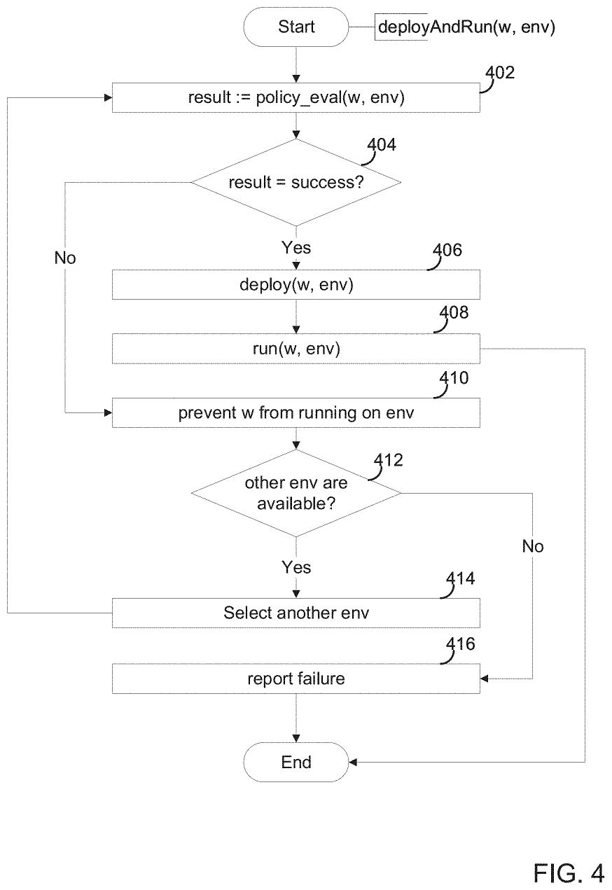

FIG. 4 depicts a flow of operations for a deploy and run function, according to an embodiment. The deploy and run function may run as an application 282 in a management server such as management server 108 and use the software stack described in reference to FIG. 2C. The function bases its decision on a given workload w and environment env, where an environment is a set of resources on which the workload may run. The environment may be a host computer, a storage array, a cluster of host computers, a software-defined data center, and a physical data center.

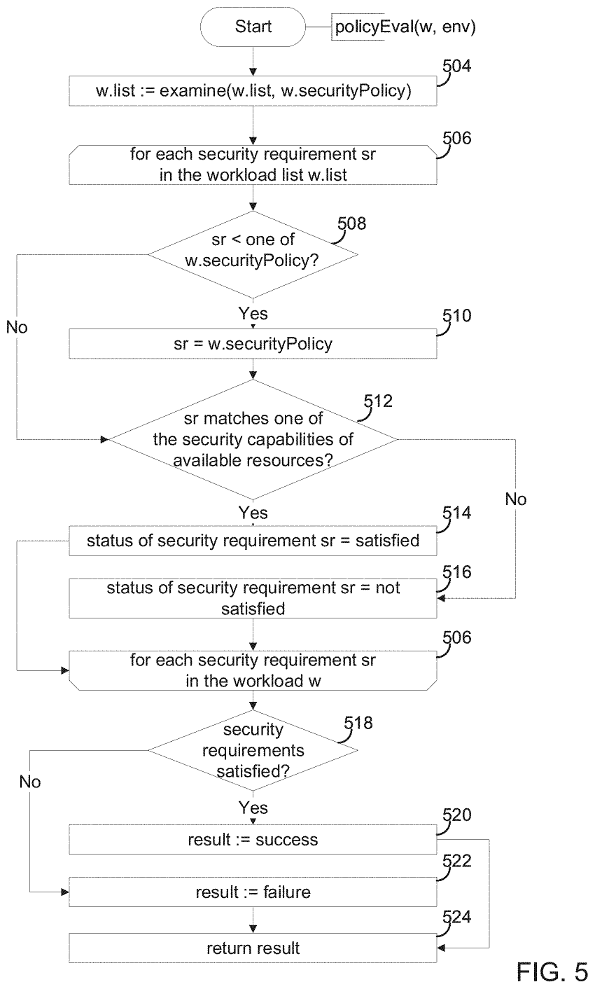

In step 402, the function invokes the policy evaluation function, policy_eval(w, env) using the given workload w and environment, env. The policy evaluation function is further described in reference to FIG. 5. In step 404, the function determines if the result of the policy evaluation function is a success or not. If the result is a success, then in step 406, the function deploys the workload w onto the environment env. In step 408, the function then runs the workload on the resources of the environment. However, if in step 404, the function determines that the environment cannot meet the requirements of the workload w, then the function prevents in step 410 the workload w from running on the environment. In step 412, the function looks for other environments that are available, and if other environments are available, selects the other environment in step 414. The function then goes back to step 402 to run the policy evaluation function again to determine if the selected environment satisfies the workload w's requirements. If the function determines in step 404 that the selected environment does satisfy the workload, then in step 406, the function deploys the workload to the environment and in step 408 runs the workload w on the environment env. In some embodiments, if live migration of the workload is possible, the workload is live migrated to the new environment in accordance with known techniques for live migration. If no environment is available that satisfies the workload requirements, as determined in step 412, then in step 416, the function reports a failure, because it cannot find a suitable environment for the workload.

FIG. 5 depicts a flow of operations for the policy evaluation function, according to an embodiment. The policy evaluation function may run as an application 282 in a management server such as management server 108 and use the software stack described in reference to FIG. 2C. The function is invoked with a specified workload and environment.

In step 504, the function examines and parses the list of security requirements of the workload w against the security policy for the workload. If parsing the security policy for the workload indicates that fewer security requirements than those specified by the workload are required, then the function uses the security requirements specified by the workload. If parsing the security policy indicates that more security requirements than those specified by the workload are required, then the function uses the security requirements specified by the policy for the workload. Thus, elements of the security policy for the workload may override the security requirements specified by the workload itself.

In step 506, the function starts an iterator over the list of security requirements for a given workload w, such as a virtual machine or a virtual disk.

In step 508, the function determines whether a security requirement of the workload, sr, is less restrictive than that of the security policy for the workload. If so, then in step 510, the security policy is adopted instead of the security requirement of the workload. Thus, security requirements of the security policy override the security requirements of the workload. For example, if the security policy for a virtual disk is long data retention, and the security requirement for the virtual disk as a workload only requires short data retention, the stricter requirement (e.g., long data retention) is selected and becomes the security requirement for the workload.

In step 512, if the security requirement sr matches a corresponding one of the security capabilities of the available resources, then in step 514, the status of the security requirement sr is set to satisfied. If the security requirement sr does not match a corresponding one of the capabilities of the available resources, then the status of the security requirement sr is set to not satisfied in step 516. For example, a security policy for the virtual machine may be geofencing: US only, and this requirement would be met by a host computer that is in a physical data center located in the US.

In step 518, if the list of security requirements is satisfied, then in step 520, the function sets the result to success. In step 522, if the list of security requirements is not satisfied, then the function sets the result to failure, and in step 524 returns the result.

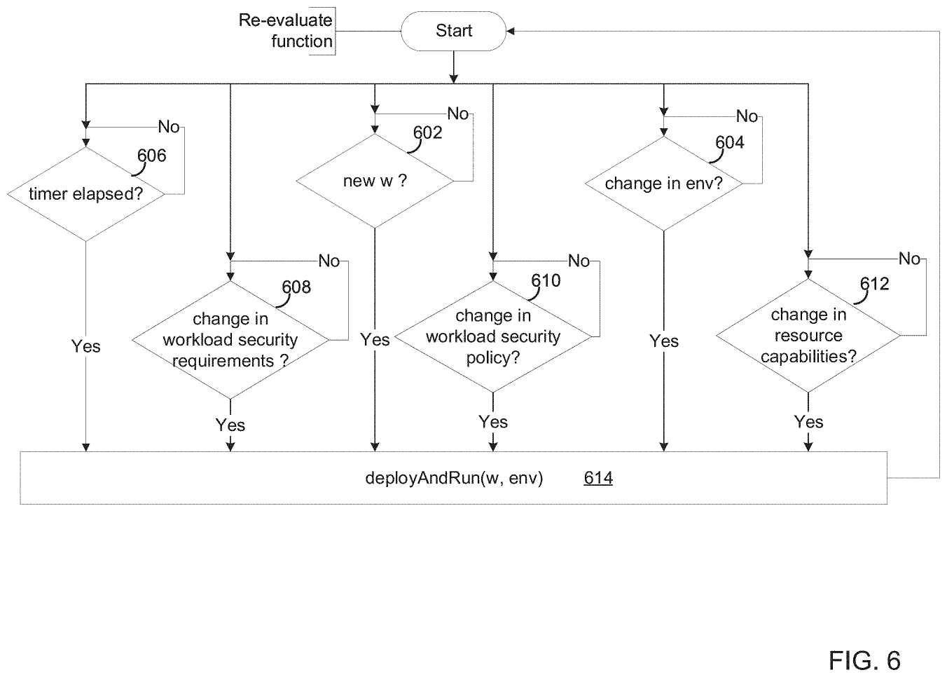

FIG. 6 depicts a flow of operations for a re-evaluation function, according to an embodiment. The re-evaluation function may run as an application 282 in a management server such as management server 108 and use the software stack described in reference to FIG. 2C.

In step 602, the function determines whether there is a newly introduced workload on the existing environment. In step 604, the function determines whether or not the current environment has changed. For example, a storage array may have been added to a host computer system of the current environment, or more processors may have been added to the host computer system. In step 606, the function determines whether a timer has elapsed. The timer is set, for example, to perform a re-evaluation on a periodic basis. In step 608, the function determines whether there is any change in the workload security requirements. In step 610, the function determines whether there is any change in the security policy. If step 612, the function determines whether there is any change in the security capabilities of the resources of the current environment. If any of the steps 602-612 occurs, then the function invokes in step 614 the deploy and run function (FIG. 4) with the changed workload w and environment env. Thus, any change in the workload or environment triggers an invocation of the deploy and run function, which in turn triggers a policy evaluation (FIG. 5) of the changed workload or changed environment or both. The change may cause the environment to be unsuitable for the workload. If so, the deploy and run function may select another environment and re-invoke the policy evaluation function to determine if the environment is suitable. If so, then the function may deploy the workload onto the other environment.

Thus, invoking the policy evaluation function while the workloads are active and if and when a change occurs in the workloads or the resources, permits dynamic management of the running environment based on the security requirements of the workloads and capabilities of resources on which those workloads run and a user policy for the workload.

The various embodiments described herein may employ various computer-implemented operations involving data stored in computer systems. For example, these operations may require physical manipulation of physical quantities—usually, though not necessarily, these quantities may take the form of electrical or magnetic signals, where they or representations of them are capable of being stored, transferred, combined, compared, or otherwise manipulated. Further, such manipulations are often referred to in terms, such as producing, identifying, determining, or comparing. Any operations described herein that form part of one or more embodiments of the invention may be useful machine operations. In addition, one or more embodiments of the invention also relate to a device or an apparatus for performing these operations. The apparatus may be specially constructed for specific required purposes, or it may be a general-purpose computer selectively activated or configured by a computer program stored in the computer. In particular, various general-purpose machines may be used with computer programs written in accordance with the teachings herein, or it may be more convenient to construct a more specialized apparatus to perform the required operations.

The various embodiments described herein may be practiced with other computer system configurations including hand-held devices, microprocessor systems, microprocessor-based or programmable consumer electronics, minicomputers, mainframe computers, and the like.

One or more embodiments of the present invention may be implemented as one or more computer programs or as one or more computer program modules embodied in one or more computer-readable media. The term computer-readable medium refers to any data storage device that can store data which can thereafter be input to a computer system—computer-readable media may be based on any existing or subsequently developed technology for embodying computer programs in a manner that enables them to be read by a computer. Examples of a computer-readable medium include a hard drive, network attached storage (NAS), read-only memory, random-access memory (e.g., a flash memory device), a CD (Compact Discs)—CD-ROM, a CD-R, or a CD-RW, a DVD (Digital Versatile Disc), a magnetic tape, and other optical and non-optical data storage devices. The computer-readable medium can also be distributed over a network coupled computer system so that the computer-readable code is stored and executed in a distributed fashion.

Although one or more embodiments of the present invention have been described in some detail for clarity of understanding, it will be apparent that certain changes and modifications may be made within the scope of the claims. Accordingly, the described embodiments are to be considered as illustrative and not restrictive, and the scope of the claims is not to be limited to details given herein, but may be modified within the scope and equivalents of the claims. In the claims, elements and/or steps do not imply any particular order of operation, unless explicitly stated in the claims.

Virtualization systems in accordance with the various embodiments may be implemented as hosted embodiments, non-hosted embodiments or as embodiments that tend to blur distinctions between the two, are all envisioned. Furthermore, various virtualization operations may be wholly or partially implemented in hardware. For example, a hardware implementation may employ a look-up table for modification of storage access requests to secure non-disk data.

Certain embodiments as described above involve a hardware abstraction layer on top of a host computer. The hardware abstraction layer allows multiple contexts to share the hardware resource. In one embodiment, these contexts are isolated from each other, each having at least a user application running therein. The hardware abstraction layer thus provides benefits of resource isolation and allocation among the contexts. In the foregoing embodiments, virtual machines are used as an example for the contexts and hypervisors as an example for the hardware abstraction layer. As described above, each virtual machine includes a guest operating system in which at least one application runs. It should be noted that these embodiments may also apply to other examples of contexts, such as containers not including a guest operating system, referred to herein as “OS-less containers” (see, e.g., www.docker.com). OS-less containers implement operating system level virtualization, wherein an abstraction layer is provided on top of the kernel of an operating system on a host computer. The abstraction layer supports multiple OS-less containers, each including an application and its dependencies. Each OS-less container runs as an isolated process in user space on the host operating system and shares the kernel with other containers. The OS-less container relies on the kernel's functionality to make use of resource isolation (CPU, memory, block I/O, network, etc.) and separate namespaces and to completely isolate the application's view of the operating environments. By using OS-less containers, resources can be isolated, services restricted, and processes provisioned to have a private view of the operating system with their own process ID space, file system structure, and network interfaces. Multiple containers can share the same kernel, but each container can be constrained to only use a defined amount of resources such as CPU, memory, and I/O. The term “virtualized computing instance,” as used herein, is meant to encompass both VMs and OS-less containers.

Many variations, modifications, additions, and improvements are possible, regardless the degree of virtualization. The virtualization software can therefore include components of a host, console, or guest operating system that performs virtualization functions. Plural instances may be provided for components, operations or structures described herein as a single instance. Boundaries between various components, operations and data stores are somewhat arbitrary, and particular operations are illustrated in the context of specific illustrative configurations. Other allocations of functionality are envisioned and may fall within the scope of the invention(s). In general, structures and functionality presented as separate components in exemplary configurations may be implemented as a combined structure or component. Similarly, structures and functionality presented as a single component may be implemented as separate components. These and other variations, modifications, additions, and improvements may fall within the scope of the appended claim(s).

What is claimed is:

1. A method for placing a workload on one or more resources based on security requirements of the workload, a declared security policy, and security capabilities of the resources, the method comprising:
determining the security requirements of the workload and the declared security policy;
searching for and finding a resource that meets the security requirements of the workload and the declared security policy; and
deploying the workload onto the resource.

2. The method of claim 1, further comprising:
upon a lapsing of a timer, re-evaluating the declared security policy and the security requirements against the security capabilities of the resource to determine whether the workload is to continue to run on the resource.

3. The method of claim 1, further comprising:
after deploying the workload onto the resource, discovering that the resource does not meet the security requirements of the workload and the declared security policy due to a change in the security requirements of the workload, the declared security policy, or the security capabilities of the resource;
determining that a new environment has a resource having security capabilities that meet the security requirements of the workload and the declared security policy; and
deploying the workload onto the resource in the new environment.

4. The method of claim 3, wherein the new environment is determined to have the resource having security capabilities that meet the security requirements of the workload and the declared security policy by:
selecting an environment among a set of available environments;
evaluating the declared security policy and security requirements of the workload against the security capabilities of resources in the selected environment; and
making the selected environment become the new environment if the evaluation succeeds.

5. The method of claim 1, wherein the security requirements of the declared security policy override the security requirements of the workload.

6. The method of claim 5, wherein the security requirements of the declared security policy are more restrictive than the security requirements of the workload.

7. The method of claim 5, wherein the security requirements of the declared security policy are fewer in number than a number of the security requirements of the workload.

8. A system placing a workload on one or more resources based on security requirements of the workload, a declared security policy, and security capabilities of the resources, the system comprising:
one or more processors; and
a memory into which system software is loaded and run by the one or more processors, wherein the system software is configured to:
determine the security requirements of the workload and the declared security policy;
search for and find a resource that meets the security requirements of the workload and the declared security policy; and
deploy the workload onto the resource.

9. The system of claim 8, wherein the system software is configured to:
upon a lapsing of a timer, re-evaluate the declared security policy and the security requirements against the security capabilities of the resource to determine whether the workload is to continue to run on the resource.

10. The system of claim 8, wherein the system software is further configured to:
discover, after deploying the workload onto the resource, that the resource does not meet the security requirements of the workload and the declared security policy due to a change in the security requirements of the workload, the declared security policy, or the security capabilities of the resource;
determine that a new environment has a resource having security capabilities that meet the security requirements of the workload and the declared security policy; and
deploy the workload onto the resource in the new environment.

11. The system of claim 10, wherein the system software determines that the new environment has the resource having security capabilities that meet the security requirements of the workload and the declared security policy by:
selecting an environment among a set of available environments;
evaluating the declared security policy and security requirements of the workload against the security capabilities of resources in the selected environment; and
making the selected environment become the new environment if the evaluation succeeds.

12. The system of claim 8, wherein the security requirements of the declared security policy override the security requirements of the workload.

13. The system of claim 12, wherein the security requirements of the declared security policy are more restrictive than the security requirements of the workload.

14. The system of claim 12, wherein the security requirements of the declared security policy are fewer in number than a number of security requirements of the workload.

15. A non-transitory computer-readable medium containing instructions executable in a computer system, wherein the instructions when executed in the computer system cause the computer system to carry out a method for placing a workload on one or more resources based on security requirements of the workload, a declared security policy, and security capabilities of the resources, the method comprising:
determining the security requirements of the workload and the declared security policy;
searching for and finding a resource that meets the security requirements of the workload and the declared security policy; and
deploying the workload onto the resource.

16. The non-transitory computer-readable medium of claim 15, wherein the method further comprises:
upon a lapsing of a timer, re-evaluating the declared security policy and the security requirements against the security capabilities of the resource to determine whether the workload is to continue to run on the resource.

17. The non-transitory computer-readable medium of claim 15, wherein the method further comprises:
after deploying the workload onto the resource, discovering that the resource does not meet the security requirements of the workload and the declared security policy due to a change in the security requirements of the workload, the declared security policy, or the security capabilities of the resource;
determining that a new environment has a resource having security capabilities that meet the security requirements of the workload and the declared security policy; and
deploying the workload onto the resource in the new environment.

18. The non-transitory computer-readable medium of claim 17, wherein the new environment is determined to have the resource having security capabilities that meet the security requirements of the workload and the declared security policy by:
selecting an environment among a set of available environments;
evaluating the declared security policy and security requirements of the workload against the security capabilities of resources in the selected environment; and
making the selected environment become the new environment if the evaluation succeeds.

19. The non-transitory computer-readable medium of claim 15, wherein the security requirements of the declared security policy override the security requirements of the workload.

20. The non-transitory computer-readable medium of claim 19, wherein the security requirements of the declared security policy are more restrictive than the security requirements of the workload.
